(19) United States
(12) Patent Application Publication
(10) Pub. No.: US 2019/0131858 A1
(43) Pub. Date: May 2, 2019

(54) MOTOR AND ROTARY DRIVE APPARATUS

(71) Applicant: Nidec Corporation, Kyoto (JP)

(72) Inventor: Junya MIZUKAMI, Kyoto (JP)

(21) Appl. No.: 16/145,312

(22) Filed: Sep. 28, 2018

(30) Foreign Application Priority Data
Oct. 26, 2017 (JP) 2017-207137

(51) Int. Cl. H02K 21/22; H02K 7/04; H02K 11/00; H02K 11/22

(52) U.S. Cl. CPC H02K 21/222; H02K 11/22; H02K 11/0094; H02K 7/04

(57) ABSTRACT

A motor includes a stationary portion including a stator, and a rotating portion supported to be rotatable about a central axis extending in a vertical direction with respect to the stationary portion. The rotating portion includes a rotor hub portion extending in an annular shape around the central axis, a magnet including a pole surface radially opposite to the stator, a yoke fixed to a radial outside of the magnet, and connected to the rotor hub portion, a flywheel axially above the rotor hub portion, a first seal portion extending in an annular shape radially outside of the yoke; and a second seal portion extending in an annular shape radially outside of the first seal portion.

### CROSS REFERENCE TO RELATED APPLICATIONS

This application claims the benefit of priority to Japanese Patent Application No. 2017-207137 filed on Oct. 26, 2017. The entire contents of this application are hereby incorporated herein by reference.

### BACKGROUND OF THE INVENTION

### 1. Field of the Invention

The present invention relates to a motor and a rotary drive apparatus.

### 2. Description of the Related Art

JP-A 2017-011448 describes a motor designed to reduce the likelihood of a diffuse reflection of light emitted from a light source. The motor includes a rotating portion including a rotor hub extending in an annular shape around a shaft, and a flywheel portion fixed to the rotor hub. A reflectivity of an outer circumferential surface of the flywheel portion is arranged to be lower than a reflectivity of a surface of the rotor hub which faces outward to reduce the likelihood of a diffuse reflection of light inside of a casing in which the motor is installed.

In the motor described in JP-A 2017-011448, which is an outer-rotor motor, a shoulder or a gap is defined between the rotor hub and the flywheel portion. Therefore, when a seal portion capable of reflecting light is fixed to an outer circumferential surface of a rotor with the view of sensing the rotational position of the motor, the seal portion may be tilted or bent, which may affect travel of reflected light. This in turn may lead to an error in accuracy in sensing the rotational position of the motor on the basis of the reflected light. In addition, a reduction in workability in fixing the seal portion to the outer circumferential surface of the rotor may occur.

### SUMMARY OF THE INVENTION

A motor according to a preferred embodiment of the present invention includes a stationary portion including a stator, and a rotating portion supported to be rotatable about a central axis extending in a vertical direction with respect to the stationary portion. The rotating portion includes a rotor hub portion extending in an annular shape around the central axis; a magnet including a pole surface radially opposite to the stator; a yoke fixed to a radial outside of the magnet, and connected to the rotor hub portion; a flywheel axially above the rotor hub portion; a first seal portion extending in an annular shape radially outside of the yoke; and a second seal portion extending in an annular shape radially outside of the first seal portion. At least a portion of the first seal portion is located in a first groove portion, the first groove portion being a space positioned radially inside of the second seal portion and radially outside of the yoke. The second seal portion is in contact with at least a portion of an outer circumferential surface of the first seal portion and at least one of an outer circumferential surface of the flywheel and an outer circumferential surface of the rotor hub portion over an entire circumferential extent thereof.

According to the above preferred embodiment of the present invention, a reduction in the likelihood that the second seal portion, which is fixed to an outer circumferential surface of the rotating portion, will be tilted or bent is able to be achieved. In addition, an improvement in workability in fixing the second seal portion to the outer circumferential surface of the rotating portion is able to be achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a planar view of a motor according to a first preferred embodiment of the present invention.

FIG. 2 is a vertical sectional view of the motor according to the first preferred embodiment of the present invention.

FIG. 3 is a partial vertical sectional view of the motor according to the first preferred embodiment of the present invention.

FIG. 4 is a vertical sectional view of a sleeve according to the first preferred embodiment of the present invention.

FIG. 5 is a bottom view of the sleeve according to the first preferred embodiment of the present invention.

FIG. 6 is a partial vertical sectional view of a motor according to a second preferred embodiment of the present invention.

FIG. 7 is a partial vertical sectional view of a motor according to a modification of the second preferred embodiment of the present invention.

FIG. 8 is a partial vertical sectional view of a motor according to another modification of the second preferred embodiment of the present invention.

FIG. 9 is a partial vertical sectional view of a motor according to a third preferred embodiment of the present invention.

FIG. 10 is a partial vertical sectional view of a motor according to a modification of the third preferred embodiment of the present invention.

### DETAILED DESCRIPTION OF THE PREFERRED EMBODIMENTS

Hereinafter, motors according to preferred embodiments of the present invention will be disclosed. It is assumed herein that a direction parallel to a central axis of a motor is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a flywheel is arranged with respect to a rotor hub portion is an upper side, and the shape of each member or portion and relative positions of different members or portions will be described based on the above assumptions. It should be noted, however, that the above definitions of the vertical direction and the upper and lower sides are not meant to restrict in any way the orientation of a motor according to any preferred embodiment of the present invention at the time of manufacture or when in use.

### 1. First Preferred Embodiment

### 1-1. Structure of Motor

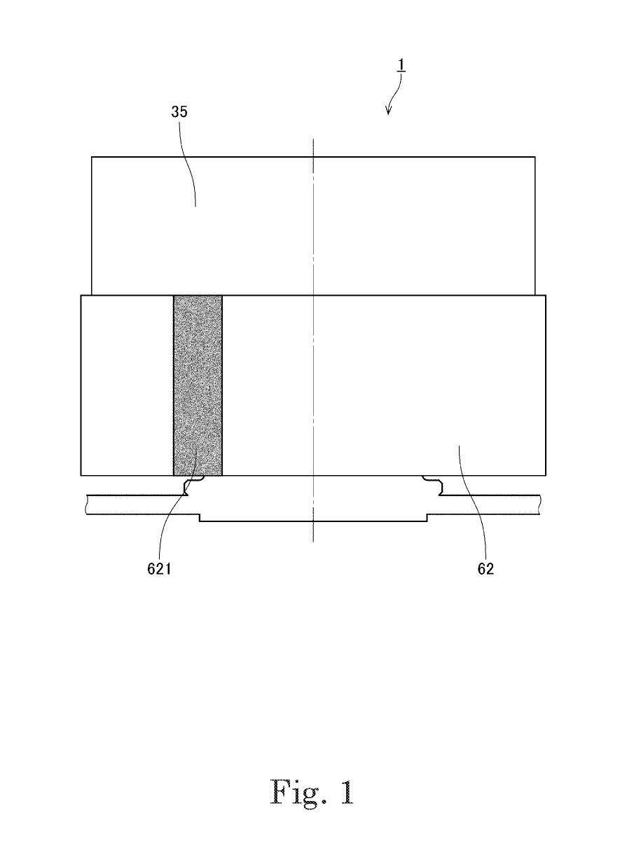

FIG. 1 is a planar view of a motor 1 according to a first preferred embodiment of the present invention as viewed from the front. Referring to FIG. 1, the motor 1 includes a reflection portion 621. The reflection portion 621 is arranged to reflect incoming light coming from a light source (not shown) arranged outside of the motor 1. In addition, a sensing mechanism (not shown) is arranged outside of the motor 1. The sensing mechanism includes a light receiving portion arranged to receive reflected light obtained by reflection of the incoming light by the reflection portion 621. The rotational position of a flywheel 35, which is arranged to rotate together with the motor 1, is sensed by the sensing mechanism (not shown). The motor 1, the light source, and the sensing mechanism together constitute a rotary drive apparatus.

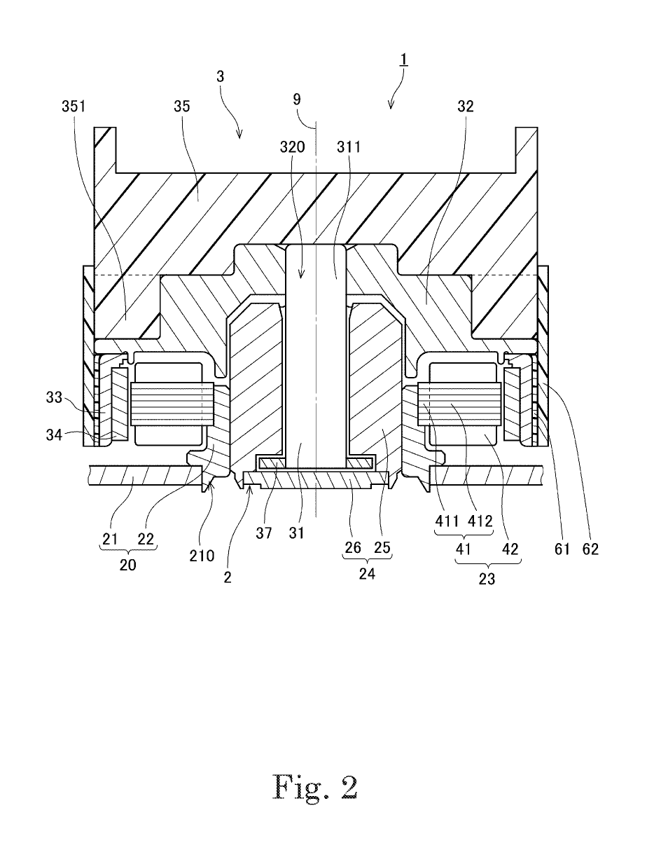

FIG. 2 is a vertical sectional view of the motor 1. Referring to FIG. 2, the motor 1 includes a stationary portion 2 and a rotating portion 3. The rotating portion 3 is supported to be rotatable about a central axis 9, which extends in the vertical direction, with respect to the stationary portion 2.

The stationary portion 2 includes a base portion 20, a stator 23, and a bearing portion 24.

The base portion 20 is arranged to support the stator 23, which will be described below. The base portion 20 includes a base body 21 and a stator holder 22.

The base body 21 is a plate-shaped member arranged to support the stator holder 22. A metal, such as, for example, an aluminum alloy or stainless steel, is used as a material of the base body 21. The base body 21 is extending radially outward from an outer circumference of the stator holder 22. When the motor 1 is used, the base body 21 is, for example, fixed to a casing or the like in which the motor 1 is arranged through screws or the like. Note that a circuit board (not shown), which is arranged to supply electric drive currents to the motor 1, may be arranged on or embedded in an upper surface or a lower surface of the base body 21.

The stator holder 22 is a cylindrical member extending in the axial direction. A lower end portion of the stator holder 22 is inserted in a through hole 210 of the base body 21, and is fixed to the base body 21 by crimping. Note, however, that the stator holder 22 may alternatively be fixed to the base body 21 by another method, such as, for example, welding. Also note that the base body 21 and the stator holder 22 may alternatively be defined by a single continuous monolithic member.

The stator 23 is an armature including a stator core 41 and a plurality of coils 42. The stator 23 is arranged above at least a portion of the base portion 20. The stator core 41 is defined by, for example, laminated steel sheets, that is, electromagnetic steel sheets, such as silicon steel sheets, placed one upon another in the axial direction. The stator core 41 is directly supported by the base portion 20 by being fixed to an outer circumferential surface of the stator holder 22 through, for example, an adhesive. Note that the stator 23 may alternatively be indirectly supported by the base portion 20 with another member (not shown) interposed therebetween.

In addition, the stator core 41 includes a core back 411 in the shape of a circular ring, and a plurality of teeth 412 arranged to project radially outward from the core back 411. The coils 42 are a collection of conducting wires wound around the teeth 412. The electric drive currents for the motor 1 are supplied from an external power supply (not shown) to the coils 42 through the aforementioned circuit board and the conducting wires. The teeth 412 and the coils 42 are preferably arranged in the form of a circular ring and at substantially regular intervals in a circumferential direction about the central axis 9.

The bearing portion 24 is a member arranged to rotatably support a shaft 31, which will be described below. The bearing portion 24 includes a sleeve 25 extending in the axial direction to assume a substantially cylindrical shape around the shaft 31, and a disk-shaped cap 26 arranged to close an opening at a lower end portion of the sleeve 25. An inner circumferential surface of the sleeve 25 is arranged radially opposite to an outer circumferential surface of the shaft 31. A lower portion of the sleeve 25 is inserted into a space radially inside of the stator holder 22, and is fixed to the stator holder 22 through, for example, an adhesive. An upper end portion of the sleeve 25 is arranged axially above an upper end portion of the stator holder 22 and an upper end portion of the stator 23. The structure of the bearing portion 24 will be described in more detail below.

The rotating portion 3 includes the shaft 31, a rotor hub portion 32, a yoke 33, a magnet 34, the flywheel 35, a first seal portion 61, which will be described below, and a second seal portion 62, which will be described below.

The shaft 31 is a columnar member extending in the axial direction along the central axis 9. The shaft 31 may be defined integrally with the rotor hub portion 32 or be defined by a member separate from the rotor hub portion 32. A metal, such as stainless steel, for example, is used as a material of the shaft 31. The outer circumferential surface of the shaft 31 and the inner circumferential surface of the sleeve 25 are arranged radially opposite to each other with a slight gap therebetween. In addition, a disk-shaped shaft annular portion 37, which is extending radially outward from a lower end portion of the shaft 31, is fixed to a lower portion of the shaft 31. An upper surface of the shaft annular portion 37 and a lower surface of the sleeve 25 are arranged axially opposite to each other with a slight gap therebetween. In addition, a lower surface of the shaft annular portion 37 and an upper surface of the cap 26 are arranged axially opposite to each other with a slight gap therebetween. Note that the shaft 31 and the shaft annular portion 37 may alternatively be defined by a single monolithic member.

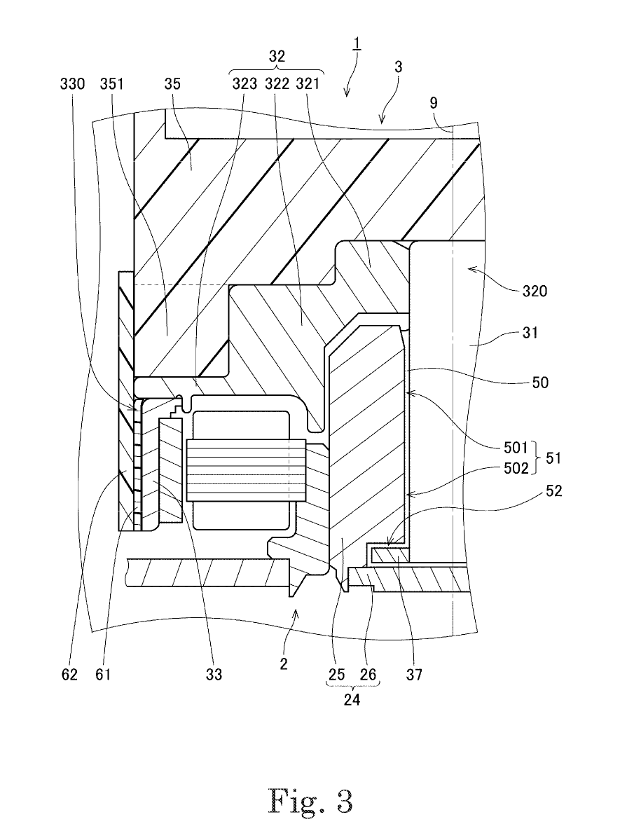

The rotor hub portion 32 is a member extending in an annular shape around the central axis 9. A metal, such as, for example, a stainless metal, an aluminum alloy, or the like, is used as a material of the rotor hub portion 32. FIG. 3 is a partial vertical sectional view of the motor 1. Referring to FIG. 3, the rotor hub portion 32 includes a joining portion 321, a cylindrical portion 322, and a flange portion 323. The joining portion 321 is arranged most radially inward in the rotor hub portion 32, and is fixed to the outer circumferential surface of the shaft 31. The cylindrical portion 322 is extending in the axial direction to assume a cylindrical shape radially outside of the joining portion 321. The flange portion 323 is extending radially outward from a lower portion of the cylindrical portion 322. A through hole 320 passing through the rotor hub portion 32 in the axial direction is defined radially inside of the joining portion 321. An upper end portion 311 of the shaft 31 is press fitted in the through hole 320 of the rotor hub portion 32. Note, however, that the shaft 31 and the rotor hub portion 32 may alternatively be fixed to each other by another method, such as, for example, adhesion or shrink fitting.

The yoke 33 is a cylindrical member fixed to a radial outside of the magnet 34, which will be described below, to hold the magnet 34. An outer circumferential surface of the magnet 34 is fixed to an inner circumferential surface of the yoke 33. The yoke 33 is arranged to be substantially coaxial with the central axis 9. An upper end portion of the yoke 33 is fixed to a lower surface of a radially outer portion of the flange portion 323 of the rotor hub portion 32 through an adhesive or by crimping, for example. A magnetic material, such as, for example, iron, is used as a material of the yoke 33. Use of the yoke 33 made of the magnetic material contributes to preventing magnetic flux generated from the magnet 34 from escaping outward.

The magnet 34 is fixed to the inner circumferential surface of the yoke 33 through, for example, an adhesive. A permanent magnet in the shape of a circular ring is used as the magnet 34 according to the present preferred embodiment. The magnet 34 is arranged radially outside of the stator 23. An inner circumferential surface of the magnet 34 includes north and south poles arranged to alternate with each other in the circumferential direction. In addition, the inner circumferential surface of the magnet 34 is arranged radially opposite to a radially outer end surface of each of the plurality of teeth 412 with a slight gap therebetween. That is, the magnet 34 includes a pole surface arranged radially opposite to the stator 23. Note that a plurality of magnets may be used in place of the magnet 34 in the shape of a circular ring. In the case where the plurality of magnets are used, the magnets are arranged on the inner circumferential surface of the yoke 33 such that pole surfaces of the north poles and pole surfaces of the south poles alternate with each other in the circumferential direction.

Once the electric drive currents are supplied to the coils 42 in the motor 1 described above, magnetic flux is generated around each of the teeth 412, which serve as magnetic cores for the coils 42. In addition, a magnetic circuit passing through the stator 23, the magnet 34, and the yoke 33 is defined. Then, interaction between the magnetic flux of the teeth 412 and magnetic flux of the magnet 34 produces a circumferential torque between the stationary portion 2 and the rotating portion 3, so that the rotating portion 3 is caused to rotate about the central axis 9 with respect to the stationary portion 2 through the bearing portion 24.

The flywheel 35 is arranged axially above the rotor hub portion 32. The flywheel 35 is fixed to the rotor hub portion 32 through, for example, an adhesive. Accordingly, the flywheel 35 is arranged to rotate about the central axis 9 together with the rotating portion 3. An ABS resin, which is a thermoplastic resin, for example, is used as a material of the flywheel 35. Note that, instead of the ABS resin, another material, such as, for example, a thermosetting resin or a metal, may alternatively be used as the material of the flywheel 35.

In addition, the flywheel 35 according to the present preferred embodiment includes an inertia portion 351 arranged to project downward in a radially outer portion thereof. The inertia portion 351 is an annular portion arranged radially outside of the cylindrical portion 322 and axially above the flange portion 323. A lower surface of the inertia portion 351 is arranged to be in contact with an upper surface of the flange portion 323. In addition, the inertia portion 351 is fixed to an outer circumferential surface of the cylindrical portion 322 and the upper surface of the flange portion 323 through, for example, an adhesive.

Note that the inertia portion 351 and the flywheel 35 may alternatively be defined by separate members. Also note that the inertia portion 351 may be made of a metal, such as, for example, stainless steel, and have a specific gravity greater than that of each of the flywheel 35 and the rotor hub portion 32. This will lower a center of gravity of the rotating portion 3 including the inertia portion 351, resulting in a more stable posture of the rotating portion 3. Also note that the flywheel 35 may be a resin injection-molded article produced with the inertia portion 351 as an insert. In this case, for example, a molten resin is poured into a cavity in a mold with the inertia portion 351 arranged in the mold, and the resin is cured to complete manufacture of the flywheel 35. This will accomplish molding of the flywheel 35 and fixing of the flywheel 35 to the inertia portion 351 at the same time. Thus, a reduction in the number of processes to manufacture the motor 1 can be achieved. Moreover, the flywheel 35 and the inertia portion 351 can be fixed to each other with increased strength.

### 1-2. Structure of Bearing Portion

Next, the structure of the bearing portion 24 will now be described in more detail below. Referring to FIG. 3, the stationary portion 2, which includes the sleeve 25 and the cap 26, and the rotating portion 3, which includes the shaft 31 and the shaft annular portion 37, are arranged opposite to each other with a gap therebetween. A lubricating oil 50 is arranged in the gap. A polyolester oil or a diester oil, for example, is used as the lubricating oil 50.

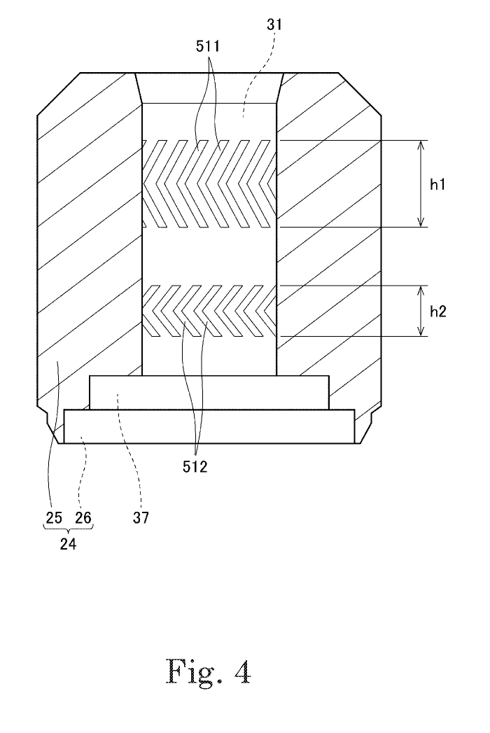

FIG. 4 is a vertical sectional view of the sleeve 25. Referring to FIG. 4, the sleeve 25 includes an upper radial groove array 511 and a lower radial groove array 512 in the inner circumferential surface thereof. The lower radial groove array 512 is arranged axially below the upper radial groove array 511. Each of the upper and lower radial groove arrays 511 and 512 is a groove array arranged in a so-called herringbone pattern. While the motor 1 is running, the upper and lower radial groove arrays 511 and 512 induce a dynamic pressure in a portion of the lubricating oil 50 which is present between the inner circumferential surface of the sleeve 25 and the outer circumferential surface of the shaft 31. This produces a radial supporting force between the sleeve 25 and the shaft 31.

That is, in this motor 1, the inner circumferential surface of the sleeve 25 and the outer circumferential surface of the shaft 31 are arranged radially opposite to each other with the lubricating oil 50 therebetween to define a radial bearing portion 51. In addition, the radial bearing portion 51 includes an upper radial bearing portion 501 arranged to generate a dynamic pressure through the upper radial groove array 511, and a lower radial bearing portion 502 arranged to generate a dynamic pressure through the lower radial groove array 512. The lower radial bearing portion 502 is arranged axially below the upper radial bearing portion 501. Note that it may be sufficient if each of the upper and lower radial groove arrays 511 and 512 is defined in one of the inner circumferential surface of the sleeve 25 and the outer circumferential surface of the shaft 31. Also note that the number of radial dynamic pressure groove arrays may alternatively be one or more than two.

In addition, referring to FIG. 4, in this motor 1, an axial dimension h1 of the upper radial groove array 511 is arranged to be greater than an axial dimension h2 of the lower radial groove array 512. Therefore, an axial dimension of the upper radial bearing portion 501 is greater than an axial dimension of the lower radial bearing portion 502. This causes the lubricating oil 50 to generate a stronger dynamic pressure at a position closer to a center of gravity of the rotating portion 3. This leads to a more stable posture of the rotating portion 3 during the rotation thereof. This in turn leads to a reduction in the likelihood that damage to the rotor hub portion 32 or the like will be caused by wobbling of the rotating portion 3.

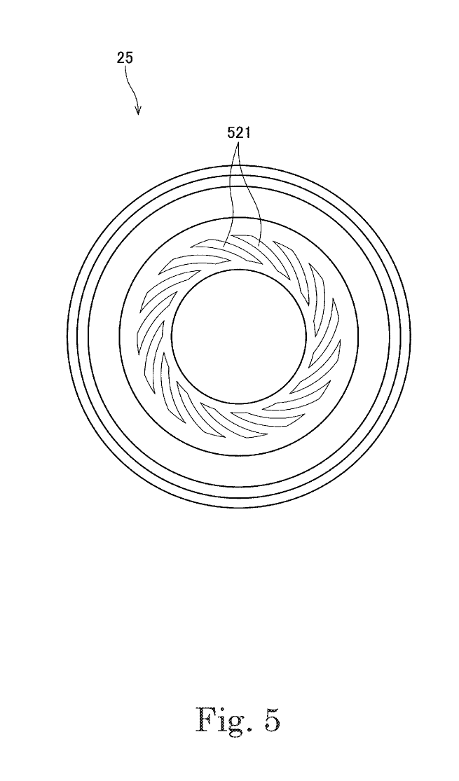

FIG. 5 is a bottom view of the sleeve 25. Referring to FIG. 5, the sleeve 25 includes a thrust groove array 521 in the lower surface thereof. The thrust groove array 521 includes a plurality of thrust grooves arranged in the circumferential direction. The thrust grooves are extending radially in a spiral shape. Note that the thrust groove array 521 may alternatively be arranged in a herringbone pattern. While the motor 1 is running, the thrust groove array 521 induces a fluid dynamic pressure in a portion of the lubricating oil 50 which is present between the lower surface of the sleeve 25 and the upper surface of the shaft annular portion 37. This produces an axial supporting force that supports the shaft annular portion 37 with respect to the sleeve 25, stabilizing the rotation of the rotating portion 3.

That is, in this motor 1, the lower surface of the sleeve 25 of the stationary portion 2 and the upper surface of the shaft annular portion 37 of the rotating portion 3 are arranged axially opposite to each other with a gap in which the lubricating oil 50 exists therebetween to define a thrust bearing portion 52. Note that it may be sufficient if the thrust groove array 521 is defined in one of the lower surface of the sleeve 25 and the upper surface of the shaft annular portion 37. Also note that the thrust bearing portion 52 may alternatively be defined between the upper surface of the cap 26 and the lower surface of the shaft annular portion 37.

As described above, a gap in the form of a bladder and including the radial bearing portion 51 and the thrust bearing portion 52 is defined between a combination of the sleeve 25 and the cap 26 and a combination of the shaft 31 and the shaft annular portion 37. This gap includes a thrust gap defined between the upper surface or the lower surface of the shaft annular portion 37 and a surface of the sleeve 25 or of the cap 26 which is axially opposite to the shaft annular portion 37, and a radial gap defined between the outer circumferential surface of the shaft 31 and a surface of the sleeve 25 which is radially opposite to the shaft 31. The lubricating oil 50 is continuously arranged in the gap including the thrust gap and the radial gap. The shaft 31 is supported through the lubricating oil 50 to be rotatable with respect to the sleeve 25 and the cap 26. In a situation in which the lubricating oil 50 has been fully arranged in the gap, a liquid surface of the lubricating oil 50 is defined only in the vicinity of the upper end portion of the sleeve 25 between the outer circumferential surface of the shaft 31 and the inner circumferential surface of the sleeve 25, that is, only at an upper end portion of the radial gap or in the vicinity of the upper end portion of the radial gap. That is, a bearing structure of this motor 1 is arranged to have a so-called full-fill structure, in which the liquid surface of the lubricating oil 50 is defined at only one position. Adoption of the full-fill structure, in which the lubricating oil 50 is sufficiently arranged between the stationary portion 2 and the rotating portion 3, contributes to more effectively preventing or reducing wobbling of the rotating portion 3 due to the orientation in which the motor 1 is installed and/or vibration, and also contributes to preventing a contact between the stationary portion 2 and the rotating portion 3 when a shock is applied to the motor 1 during the rotation of the motor 1. In addition, a reduction in the likelihood that the reflection portion 621 in the second seal portion 62, which is fixed to an outer circumferential surface of the rotor hub portion 32 and which will be described below, will be tilted can be achieved.

As described above, a fluid dynamic bearing is defined by the combination of the sleeve 25 and the cap 26 of the stationary portion 2, the combination of the shaft 31 and the shaft annular portion 37 of the rotating portion 3, and the lubricating oil 50 arranged therebetween. The rotating portion 3 rotates about the central axis 9 while being supported by the fluid dynamic bearing. Thus, a vibration produced while the motor 1 is running is not easily transferred to the flywheel 35, which leads to a reduction in vibration of the flywheel 35. As a result, light can be guided with high accuracy, with travel of the light being affected to a limited degree. Note that the rotating portion 3 may alternatively be supported to be rotatable with respect to the stationary portion 2 using another bearing, such as, for example, a ball bearing or a plain bearing, instead of the fluid dynamic bearing.

### 1-3. Structure of Outer Circumferential Portion of Rotating Portion

Next, the structure of an outer circumferential portion of the rotating portion 3 of the motor 1 will now be described in detail below. The following description will be made with reference to FIGS. 1 to 3 appropriately.

Referring to FIGS. 2 and 3, the yoke 33 is arranged radially outward in a lower portion of the rotating portion 3. In addition, in the present preferred embodiment, the radial position of an outer circumferential surface of the yoke 33 is radially inward of both the radial position of the outer circumferential surface of the rotor hub portion 32 and the radial position of an outer circumferential surface of the flywheel 35. Then, a first groove portion 330, which is a space positioned radially outside of the yoke 33, axially below the rotor hub portion 32 and the flywheel 35, and radially inside of the second seal portion 62, which will be described below, is defined.

Reference is made back to FIG. 1. As suggested above, the reflection portion 621 is arranged in an outer circumferential portion of the motor 1. The reflection portion 621 reflects the incoming light coming from the external light source (not shown). In addition, the light receiving portion of the external sensing mechanism (not shown) receives the reflected light obtained by the reflection of the incoming light by the reflection portion 621. Thus, the rotational position of the flywheel 35, which rotates while the motor 1 is running, is sensed. The reflection portion 621 is arranged at at least one circumferential position in the second seal portion 62, which will be described below. The second seal portion 62 is attached to an outer circumferential surface of the motor 1 so as to cover an area extending in the axial direction from a position higher than a lower end portion of the outer circumferential surface of the flywheel 35 through an outer circumferential surface of the flange portion 323 of the rotor hub portion 32 to a position radially outside of a lower end portion of the yoke 33. Here, as described above, the radial position of the outer circumferential surface of the yoke 33 is radially inward of both the radial position of the outer circumferential surface of the rotor hub portion 32 and the radial position of the outer circumferential surface of the flywheel 35. Thus, a shoulder or a gap is defined at a position where the reflection portion 621 is arranged. Therefore, without the first seal portion 61, the reflection portion 621 might be tilted or bent when the reflection portion 621 is fixed, which might affect travel of the reflected light. This in turn might result in an error in sensing the rotational position of the flywheel 35. Moreover, without the first seal portion 61, a reduction in workability in fixing the second seal portion 62, including the reflection portion 621, might occur.

Accordingly, in the present preferred embodiment, at least a portion of the first seal portion 61 is arranged in the aforementioned first groove portion 330. As a result, a space in the first groove portion 330 is occupied by the first seal portion to eliminate the aforementioned shoulder or fill the aforementioned gap. The first seal portion 61 is a heat-shrinkable tube made of a resin. The first seal portion 61 is positioned so as to extend in an annular shape radially outside of the yoke 33, and is then caused to thermally shrink, whereby the first seal portion 61 can be easily attached so as to fit the shape of the first groove portion 330. This reduces or eliminates the possibility that the first seal portion 61 will be detached or fly away. In a situation in which the first seal portion 61 has been disposed, the greatest outside diameter of the first seal portion 61 is substantially equal to the greatest outside diameter of the rotor hub portion 32. In other words, at least a portion of the outer circumferential surface of the rotor hub portion 32 coincides with at least a portion of an outer circumferential surface of the first seal portion 61 when viewed in the axial direction. In addition, the greatest outside diameter of the first seal portion 61 is substantially equal to the greatest outside diameter of the flywheel 35. In other words, at least a portion of the outer circumferential surface of the flywheel 35 coincides with at least a portion of the outer circumferential surface of the first seal portion 61 when viewed in the axial direction.

After the first seal portion 61 is disposed, the second seal portion 62 is arranged to cover an area extending in the axial direction from a position higher than the lower end portion of the outer circumferential surface of the flywheel 35 through the outer circumferential surface of the flange portion 323 of the rotor hub portion 32 to a position lower than an upper end portion of the outer circumferential surface of the first seal portion 61, as suggested above. In addition, the second seal portion 62 is arranged to be in contact with the outer circumferential surface of the flywheel 35, the outer circumferential surface of the flange portion 323 of the rotor hub portion 32, and the outer circumferential surface of the first seal portion 61 over the entire circumferential extent thereof. In a situation in which the first groove portion 330 in the outer circumferential portion of the rotating portion 3 has been filled by the first seal portion 61, the second seal portion 62 is attached so as to extend in an annular shape radially outside of the first seal portion 61. This leads to improved workability in attaching the second seal portion 62. In a situation in which the attachment of the second seal portion 62 has been completed, a radially inner end portion of the second seal portion 62 lies radially outward of both a radially outer end portion of the rotor hub portion 32 and a radially outer end portion of the yoke 33.

An encoder tape (i.e., a magnetic tape), for example, is used as the second seal portion 62. The second seal portion 62 is adhered and fixed to the outer circumferential surface of the flywheel 35, the outer circumferential surface of the flange portion 323 of the rotor hub portion 32, and the outer circumferential surface of the first seal portion 61 over the entire circumferential extent thereof. The light source is arranged radially outside of the second seal portion 62. In addition, since the attachment of the second seal portion 62 is performed in a situation in which unevenness in the outer circumferential portion of the rotating portion 3 has been eliminated by the first seal portion 61, the possibility that the second seal portion 62, including the reflection portion 621, will be tilted or bent is reduced. This contributes to preventing the reflected light from being affected, and to preventing an error in sensing the rotational position of the flywheel 35.

Before the attachment of the first and second seal portions 61 and 62, both the outer circumferential surface of the rotor hub portion 32 and the outer circumferential surface of the yoke 33 are exposed to an outside. Each of a reflectivity of the outer circumferential surface of the rotor hub portion 32 and a reflectivity of the outer circumferential surface of the yoke 33 is higher than a reflectivity of the outer circumferential surface of the flywheel 35, a reflectivity of a surface of the first seal portion 61, and a reflectivity of a surface of the second seal portion 62. In addition, each of a surface of the rotor hub portion 32 and a surface of the yoke 33 is rough, and has irregularities of various sizes. If the outer circumferential surface of the rotor hub portion 32 and the outer circumferential surface of the yoke 33 were not covered by the first seal portion 61 and/or the second seal portion 62, a portion of light emitted from the light source would be reflected by the outer circumferential surface of the rotor hub portion 32 and the outer circumferential surface of the yoke 33. If this happened, the reflected light might cause a diffuse reflection inside of the casing, which might affect the aforementioned reflected light. In contrast, in the present preferred embodiment, each of the outer circumferential surface of the rotor hub portion 32 and the outer circumferential surface of the yoke 33 is covered by at least one of the first and second seal portions 61 and 62. Thus, the light coming from the light source is reflected or absorbed by the surface of at least one of the first and second seal portions 61 and 62, reducing the likelihood that the light will reach the outer circumferential surface of the rotor hub portion 32 or the outer circumferential surface of the yoke 33. This in turn contributes to preventing the reflected light as reflected by the reflection portion 621 from being affected, and to more effectively preventing an error in sensing the rotational position of the flywheel 35.

### 2. Second Preferred Embodiment

Next, the structure of a motor 1B according to a second preferred embodiment of the present invention will now be described below. Note that the second preferred embodiment will be described below with focus on differences from the first preferred embodiment, and that features of the second preferred embodiment which are shared by the first preferred embodiment will not be described to avoid redundancy.

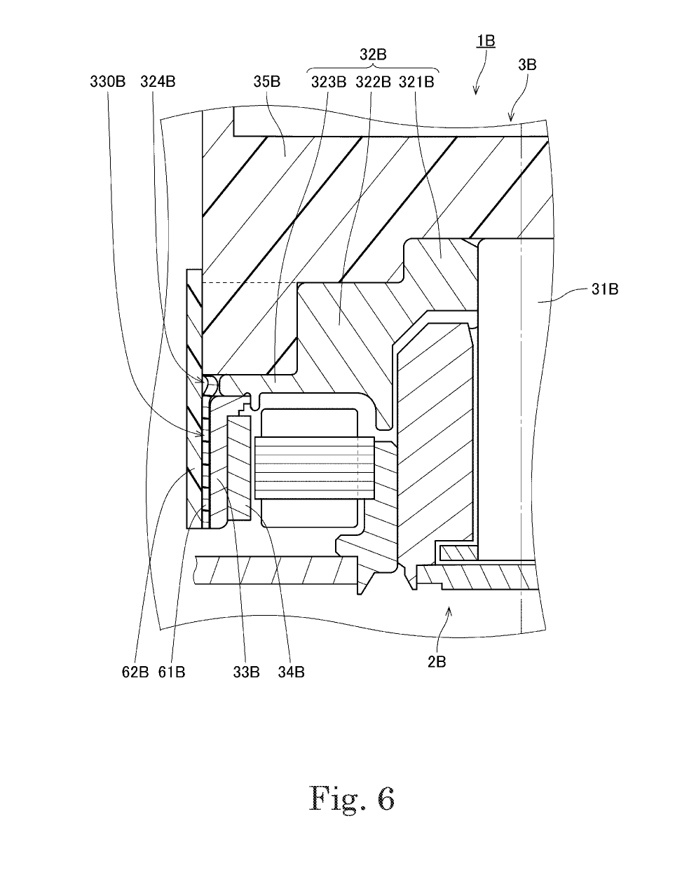

FIG. 6 is a partial vertical sectional view of the motor 1B according to the second preferred embodiment. Referring to FIG. 6, the motor 1B includes a stationary portion 2B and a rotating portion 3B. The rotating portion 3B includes a shaft 31B, a rotor hub portion 32B, a yoke 33B, a magnet 34B, a flywheel 35B, a first seal portion 61B, and a second seal portion 62B. The shaft 31B, the yoke 33B, the magnet 34B, and the flywheel 35B are similar in structure to the shaft 31, the yoke 33, the magnet 34, and the flywheel 35, respectively, according to the first preferred embodiment, and therefore, redundant descriptions thereof will be omitted.

The rotor hub portion 32B according to the present preferred embodiment includes a joining portion 321B, a cylindrical portion 322B, and a flange portion 323B. The joining portion 321B and the cylindrical portion 322B are similar in structure to the joining portion 321 and the cylindrical portion 322, respectively, according to the first preferred embodiment. The flange portion 323B is extending radially outward from a lower portion of the cylindrical portion 322B.

The radial position of an outer circumferential surface of the rotor hub portion 32B, including the flange portion 323B according to the present preferred embodiment, is radially inward of the radial position of an outer circumferential surface of the flywheel 35B. Then, a second groove portion 324B, which is a space positioned radially outside of the rotor hub portion 32B, axially below the flywheel 35B, and radially inside of the second seal portion 62B, which will be described below, is defined. In addition, the radial position of the outer circumferential surface of the rotor hub portion 32B according to the present preferred embodiment is radially inward of the radial position of an outer circumferential surface of the yoke 33B.

As is similarly the case with the first preferred embodiment, the second seal portion 62B, which includes a reflection portion (not shown), is attached to an outer circumferential surface of the motor 1B so as to cover an area extending in the axial direction from a position higher than a lower end portion of the outer circumferential surface of the flywheel 35B through a position radially outside of the rotor hub portion 32B to a position radially outside of a lower end portion of the yoke 33B. Here, as suggested above, each of the radial position of the outer circumferential surface of the yoke 33B and the radial position of the outer circumferential surface of the rotor hub portion 32B is radially inward of the radial position of the outer circumferential surface of the flywheel 35B. Thus, a shoulder or a gap is defined at a position where the reflection portion is arranged. Therefore, without the first seal portion 61B, the reflection portion might be tilted or bent when the reflection portion is fixed, which might affect travel of the reflected light. This in turn might result in an error in sensing the rotational position of the flywheel 35B. Moreover, without the first seal portion 61B, a reduction in workability in fixing the second seal portion 62B, including the reflection portion, might occur.

Accordingly, as illustrated in FIG. 6, at least a portion of the first seal portion 61B according to the present preferred embodiment is arranged in the second groove portion 324B radially outside of the rotor hub portion 32B, in addition to a portion of the first seal portion 61B being arranged in a first groove portion 330B radially outside of the yoke 33B. Thus, a space in the first groove portion 330B and the second groove portion 324B is occupied by the first seal portion 61B to eliminate the aforementioned shoulder or fill the aforementioned gap. Then, in a situation in which the first groove portion 330B and the second groove portion 324B in an outer circumferential portion of the rotating portion 3B have been filled by the first seal portion 61B, the second seal portion 62B is attached so as to extend in an annular shape radially outside of the first seal portion 61B. This leads to improved workability in attaching the second seal portion 62B. In addition, the possibility that the second seal portion 62B, including the reflection portion (not shown), will be tilted or bent is reduced. This contributes to preventing the reflected light from being affected, and to preventing an error in sensing the rotational position of the flywheel 35B.

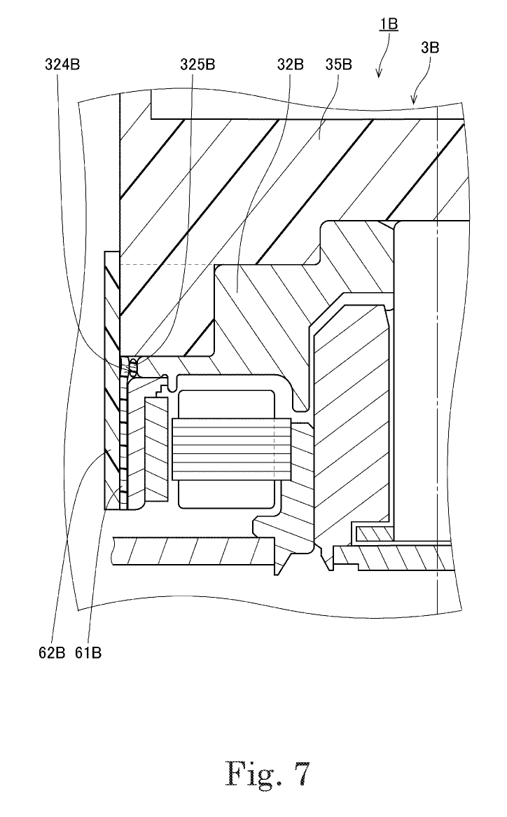

In a modification of the second preferred embodiment illustrated in FIG. 7, a rotor hub portion 32B may further include a balance correction member 325B arranged at a circumferential position within a second groove portion 324B. The balance correction member 325B is arranged to fulfill the role of correcting balance of a center of gravity of a rotating portion 3B. Use of the balance correction member 325B makes it possible to correct the balance of the center of gravity of the rotating portion 3B after a flywheel 35B is fixed to the rotor hub portion 32B. This will make rotation of the motor 1B, which has the flywheel 35B installed therein, more stable. In addition, after being arranged within the second groove portion 324B, the balance correction member 325B is covered by a first seal portion 61B and a second seal portion 62B from radially outside. That is, the balance correction member 325B is arranged radially inside of the first seal portion 61B and the second seal portion 62B. This contributes to more securely holding the balance correction member 325B.

As described above, radially outside of the rotor hub portion 32B, the second groove portion 324B is extending in the circumferential direction over the entire circumferential extent of the rotor hub portion 32B. This makes it possible to arbitrarily choose the number of balance correction members 325B and the circumferential position(s) of the balance correction member(s) 325B, and this leads to improved operating efficiency.

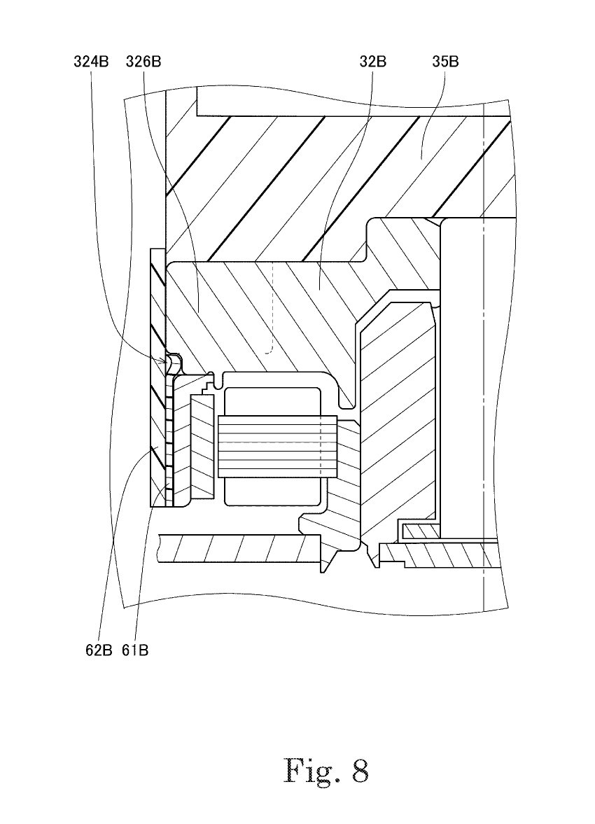

In the above-described second preferred embodiment, the flywheel 35B includes an inertia portion arranged to project downward in a radially outer portion thereof. However, in a modification of the second preferred embodiment illustrated in FIG. 8, an inertia portion 326B may be a portion of a rotor hub portion 32B. In addition, a second groove portion 324B may be a space positioned radially outside of at least a portion of the rotor hub portion 32B, axially below a flywheel 35B, and radially inside of a second seal portion 62B. Further, an outer circumferential surface of the inertia portion 326B of the rotor hub portion 32B may be arranged to coincide or overlap with an outer circumferential surface of a first seal portion 61B when viewed in the axial direction.

### 3. Third Preferred Embodiment

Next, the structure of a motor 1C according to a third preferred embodiment of the present invention will now be described below. Note that the third preferred embodiment will be described below with focus on differences from the above-described preferred embodiments, and that features of the third preferred embodiment which are shared by the above-described preferred embodiments will not be described to avoid redundancy.

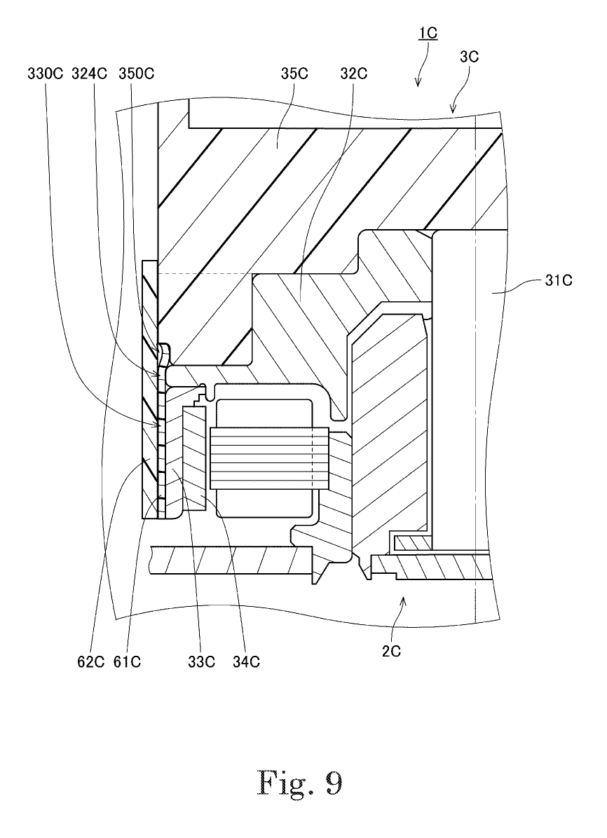

FIG. 9 is a partial vertical sectional view of the motor 1C according to the third preferred embodiment. Referring to FIG. 9, the motor 1C includes a stationary portion 2C and a rotating portion 3C. The rotating portion 3C includes a shaft 31C, a rotor hub portion 32C, a yoke 33C, a magnet 34C, a flywheel 35C, a first seal portion 61C, which will be described below, and a second seal portion 62C, which will be described below. The shaft 31C, the rotor hub portion 32C, the yoke 33C, and the magnet 34C are similar in structure to the shaft 31B, the rotor hub portion 32B, the yoke 33B, and the magnet 34B, respectively, according to the second preferred embodiment, and therefore, redundant descriptions thereof will be omitted.

The flywheel 35C according to the present preferred embodiment includes a recessed portion recessed radially inward in at least a portion, including a lower end portion, of an outer circumferential surface thereof. Because of the recessed portion, a third groove portion 350C, which is a space positioned radially outside of at least a portion of the flywheel 35C, axially above a first groove portion 330C and a second groove portion 324C, and radially inside of the second seal portion 62C, which will be described below, is defined. The third groove portion 350C is a space positioned radially outside of at least a portion, including a lower end portion, of the flywheel 35C.

As is similarly the case with the above-described preferred embodiments, the second seal portion 62C, which includes a reflection portion, is attached to an outer circumferential surface of the motor 1C so as to cover an area extending in the axial direction from an outer circumferential surface of a portion of the flywheel 35C which lies higher than the third groove portion 350C through a position radially outside of the rotor hub portion 32C to a position radially outside of a lower end portion of the yoke 33C. Here, as suggested above, each of the radial position of an outer circumferential surface of the yoke 33C, the radial position of an outer circumferential surface of the rotor hub portion 32C, and the position of a radially inner end portion of the third groove portion 350C is radially inward of the radial position of the outer circumferential surface of the portion of the flywheel 35C which lies higher than the third groove portion 350C. Thus, a shoulder or a gap is defined at a position where the reflection portion is arranged. Therefore, without the first seal portion 61C, the reflection portion might be tilted or bent when the reflection portion is fixed, which might affect travel of the reflected light. This in turn might result in an error in sensing the rotational position of the flywheel 35C. Moreover, without the first seal portion 61C, a reduction in workability in fixing the second seal portion 62C, including the reflection portion (not shown), might occur.

Accordingly, as illustrated in FIG. 9, a portion of the first seal portion 61C according to the present preferred embodiment is arranged in the third groove portion 350C in addition to portions of the first seal portion 61C being arranged in the first groove portion 330C, which lies radially outside of the yoke 33C, and the second groove portion 324C, which lies radially outside of the rotor hub portion 32C. Thus, a space in the first, second, and third groove portions 330C, 324C, and 350C is occupied by the first seal portion 61C to eliminate the aforementioned shoulder or fill the aforementioned gap. Then, in a situation in which the first, second, and third groove portions 330C, 324C, and 350C in an outer circumferential portion of the rotating portion 3C have been filled by the first seal portion 61C, the second seal portion 62C is attached so as to extend in an annular shape radially outside of the first seal portion 61C. This leads to improved workability in attaching the second seal portion 62C. In addition, the possibility that the second seal portion 62C, including the reflection portion (not shown), will be tilted or bent is reduced. This contributes to preventing the reflected light from being affected, and to preventing an error in sensing the rotational position of the flywheel 35C.

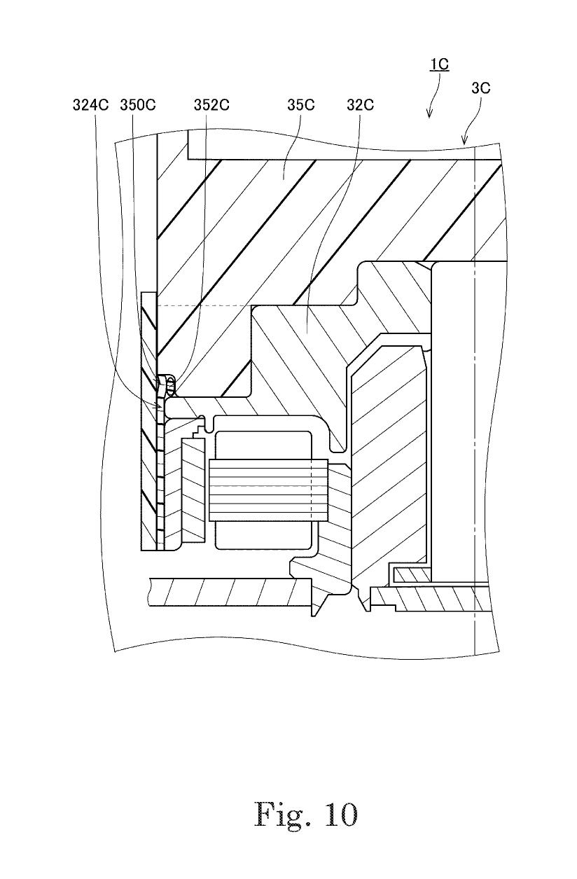

In a modification of the third preferred embodiment illustrated in FIG. 10, a flywheel 35C may further include a balance correction member 352C arranged at a circumferential position within a third groove portion 350C. This makes it possible to correct balance of a center of gravity of a rotating portion 3C after the flywheel 35C is fixed to a rotor hub portion 32C. This will make rotation of a motor 1C, which has the flywheel 35C installed therein, more stable. Here, in an outer circumferential surface of the flywheel 35C, the third groove portion 350C is extending in the circumferential direction over an entire circumferential extent of the flywheel 35C. This makes it possible to arbitrarily choose the number of balance correction members 352C and the circumferential position(s) of the balance correction member(s) 352C, and this leads to improved operating efficiency. Note, however, that it may be sufficient if the balance correction member(s) 352C is arranged in at least one of the second and third groove portions 324C and 350C.

### 4. Example Modifications

While preferred embodiments of the present invention have been described above, it will be understood that the present invention is not limited to the above-described preferred embodiments.

In each of the above-described preferred embodiments and the above-described modifications thereof, the first seal portion is a heat-shrinkable tube made of a resin. Note, however, that the first seal portion may alternatively be a tape made of a resin. Also note that it may be sufficient if, in each of the first, second, and third groove portions, at least a portion of the first seal portion is extending 360 degrees in the circumferential direction, and that both circumferential end portions of the first seal portion may overlap with each other or be slightly displaced from each other. Also note that, in each of the first, second, and third groove portions, multiple layers of at least a portion of the first seal portion may be extending 360 degrees in the circumferential direction.

In each of the above-described preferred embodiments and the above-described modifications thereof, the second seal portion is arranged to be in contact with a portion of the outer circumferential surface of the flywheel and a portion of the outer circumferential surface of the first seal portion which lies radially outside of the yoke over the entire circumferential extent thereof. Note, however, that it may be sufficient if the second seal portion is arranged to be in contact with at least a portion of the outer circumferential surface of the first seal portion and at least one of the outer circumferential surface of the flywheel and the outer circumferential surface of the rotor hub portion over the entire circumferential extent thereof.

Note that details of the structure and the shape of a motor according to a preferred embodiment of the present invention may differ from details of the structure and the shape of each motor as illustrated in the accompanying drawings of the present application. Also note that features of the above-described preferred embodiments and the modifications thereof may be combined appropriately as long as no conflict arises.

Preferred embodiments of the present invention are applicable to, for example, motors and rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a stationary portion including a stator; and
a rotating portion supported to be rotatable about a central axis extending in a vertical direction with respect to the stationary portion; wherein
the rotating portion includes:
a rotor hub portion extending in an annular shape around the central axis;
a magnet including a pole surface radially opposite to the stator;
a yoke fixed to a radial outside of the magnet, and connected to the rotor hub portion;
a flywheel axially above the rotor hub portion;
a first seal portion extending in an annular shape radially outside of the yoke; and
a second seal portion extending in an annular shape radially outside of the first seal portion;
at least a portion of the first seal portion is in a first groove portion that is a space positioned radially inside of the second seal portion and radially outside of the yoke; and
the second seal portion is in contact with at least a portion of an outer circumferential surface of the first seal portion and at least one of an outer circumferential surface of the flywheel and an outer circumferential surface of the rotor hub portion over an entire circumferential extent thereof.

2. The motor according to claim 1, wherein at least a portion of the first seal portion is in a second groove portion that is a space positioned radially inside of the second seal portion, radially outside of the rotor hub portion, and axially below the flywheel.

3. The motor according to claim 1, wherein at least a portion of the first seal portion is in a third groove portion that is a space positioned radially inside of the second seal portion and radially outside of at least a portion of the flywheel.

4. The motor according to claim 1, wherein at least a portion of the outer circumferential surface of the rotor hub portion coincides with at least a portion of the outer circumferential surface of the first seal portion when viewed in an axial direction.

5. The motor according to claim 1, wherein at least a portion of the outer circumferential surface of the flywheel coincides with at least a portion of the outer circumferential surface of the first seal portion when viewed in an axial direction.

6. The motor according to claim 1, wherein a radially inner end portion of the second seal portion is positioned radially outward of both a radially outer end portion of the rotor hub portion and a radially outer end portion of the yoke.

7. The motor according to claim 1, wherein the first seal portion is a heat-shrinkable tube made of a resin.

8. The motor according to claim 2, further comprising a balance corrector located in at least one of the second groove portion and the third groove portion and radially inside of the first seal portion.

9. A rotary drive apparatus comprising:
the motor of claim 1;
a light source; and
a sensor; wherein
the light source is radially outside of the second seal portion;
the second seal portion includes a reflector that reflects incoming light coming from the light source at at least one circumferential position; and
the sensor includes a light receiver that receives reflected light obtained by reflection of the incoming light by the reflector.
